(19) United States
(12) Patent Application Publication
(10) Pub. No.: US 2017/0323256 A1
(43) Pub. Date: Nov. 9, 2017

(54) SYSTEMS AND METHODS FOR ADJUSTING FREIGHT CHARGES FOR AN UNMANNED AERIAL VEHICLE

(71) Applicant: Elwha LLC, Bellevue, WA (US)

(72) Inventors: Jesse R. Cheatham, III, Seattle, WA (US); Hon Wah Chin, Palo Alto, CA (US); William David Duncan, JR., Sammamish, WA (US); Roderick A. Hyde, Redmond, WA (US); Muriel Y. Ishikawa, Livermore, CA (US); Jordin T. Kare, San Jose, CA (US); Tony S. Pan, Bellevue, WA (US); Robert C. Petroski, Seattle, WA (US); Clarence T. Tegreene, Mercer Island, WA (US); David B. Tuckerman, Lafayette, CA (US); Yaroslav A. Urzhumov, Bellevue, WA (US); Thomas Allan Weaver, San Mateo, CA (US); Lowell L. Wood, JR., Bellevue, WA (US); Victoria Y.H. Wood, Livermore, CA (US)

(21) Appl. No.: 15/148,960

(22) Filed: May 6, 2016

(51) Int. Cl. G06Q 10/08; B64C 39/02; G08G 5/00

(52) U.S. Cl. CPC G06Q 10/0832; G08G 5/0069; B64C 39/024; B64C 2201/128; B64C 2201/146; B64C 2201/145

(57) ABSTRACT

An unmanned aerial vehicle (UAV) may be used to deliver a package. The UAV may include a communication interface configured to receive a request to transport a package from a customer and a navigation unit configured to direct the UAV to the package. The UAV may also include a sensor configured to determine one or more physical characteristics of the package and a calculation unit configured to calculate adjusted freight charges by comparing anticipated freight charges based on one or more physical characteristics of the package specified in the request to the one or more physical characteristics of the package determined by the sensor. The UAV may further include an acceptance unit configured to accept the package for transport based on the acceptance of the adjusted freight charges by the customer.

If an Application Data Sheet (ADS) has been filed on the filing date of this application, it is incorporated by reference herein. Any applications claimed on the ADS for priority under 35 U.S.C. §§119, 120, 121, or 365(c), and any and all parent, grandparent, great-grandparent, etc. applications of such applications, are also incorporated by reference, including any priority claims made in those applications and any material incorporated by reference, to the extent such subject matter is not inconsistent herewith.

### CROSS-REFERENCE TO RELATED APPLICATIONS

The present application claims the benefit of the earliest available effective filing date(s) from the following listed application(s) (the “Priority Applications”), if any, listed below (e.g., claims earliest available priority dates for other than provisional patent applications or claims benefits under 35 USC §119(e) for provisional patent applications, for any and all parent, grandparent, great-grandparent, etc. applications of the Priority Application(s)).

### Priority Applications

None

If the listings of applications provided above are inconsistent with the listings provided via an ADS, it is the intent of the Applicant to claim priority to each application that appears in the Domestic Benefit/National Stage Information section of the ADS and to each application that appears in the Priority Applications section of this application.

All subject matter of the Priority Applications and of any and all applications related to the Priority Applications by priority claims (directly or indirectly), including any priority claims made and subject matter incorporated by reference therein as of the filing date of the instant application, is incorporated herein by reference to the extent such subject matter is not inconsistent herewith.

### TECHNICAL FIELD

This application relates to systems and methods for adjusting a pick up schedule for an unmanned aerial vehicle.

### SUMMARY

An unmanned aerial vehicle (UAV) may be configured to transport a package. In some embodiments, the UAV may be configured to receive a request to transport a package from a customer, direct the UAV to the package, and determine one or more physical characteristics of the package. The UAV may also be configured to calculate adjusted freight charges by comparing anticipated freight charges based on one or more physical characteristics of the package specified in the request to the one or more physical characteristics of the package determined by the sensor and accept the package for transport based on the acceptance of the adjusted freight charges by the customer.

In some embodiments, the UAV may be configured to receive a request to transport a package from a customer via a communication interface and direct the UAV to the package via a navigation unit. The UAV may also be configured to determine one or more physical characteristics of the package via a sensor and calculate, via a calculation unit, adjusted freight charges by comparing anticipated freight charges based on one or more physical characteristics of the package specified in the request to the one or more physical characteristics of the package determined by the sensor. The UAV may further be configured to accept, via an acceptance unit, the package for transport based on the acceptance of the adjusted freight charges by the customer.

In some embodiments, the UAV may be configured to receive a request to transport a package from a customer via a communication interface and direct the UAV to the package via a navigation unit. The UAV may also be configured to determine one or more physical characteristics of the package via a sensor and calculate, via a calculation unit, adjusted freight charges by comparing anticipated freight charges based on one or more physical characteristics of the package specified in the request to the one or more physical characteristics of the package determined by the sensor. The UAV may further be configured to accept, via an acceptance unit, the package for transport based on the acceptance of the adjusted freight charges by the customer.

### BRIEF DESCRIPTION OF THE DRAWINGS

FIG. 1 is a perspective view of an unmanned aerial vehicle configured to transport a package.

FIG. 2 is a schematic diagram of an unmanned aerial vehicle configured to transport a package.

FIG. 3 is a cross sectional view of an unmanned aerial vehicle configured to deliver a package.

FIG. 4 is a flow diagram of a method for transporting a package via an unmanned aerial vehicle.

FIG. 5 is a flow diagram of a method for transporting a package via an unmanned aerial vehicle.

FIG. 6 is a flow diagram of a method for transporting a package via an unmanned aerial vehicle.

### DETAILED DESCRIPTION OF PREFERRED EMBODIMENTS

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

There is a need to deliver packages in an efficient and concise manner. Many of the traditional package delivery systems have drawbacks in their delivery methods. For example, a traditional package delivery system may bundle a plurality of packages together for delivery and as such may delay the delivery of a single package from the plurality of packages as compared to the delivery of the single package without the single package being bundled with the plurality of packages.

Furthermore, a traditional package delivery system may also be limited in its ability to deliver a package efficiently due to infrastructure by which the package is delivered. For example, the traditional package delivery system may deliver a package using trucks that are limited by city streets infrastructure. For example, a delivery truck may be limited by rush hour traffic and/or a vehicle accident.

In some embodiments an unmanned aerial vehicle (UAV) can be configured to deliver a package. Employing a UAV to deliver a package can overcome some of the limitations faced by a traditional package delivery system. For example, the UAV is not limited by city streets infrastructure such as rush hour traffic and/or vehicle accidents. As such, the UAV configured to deliver a package may be more efficient at delivering a package than a traditional package delivery system.

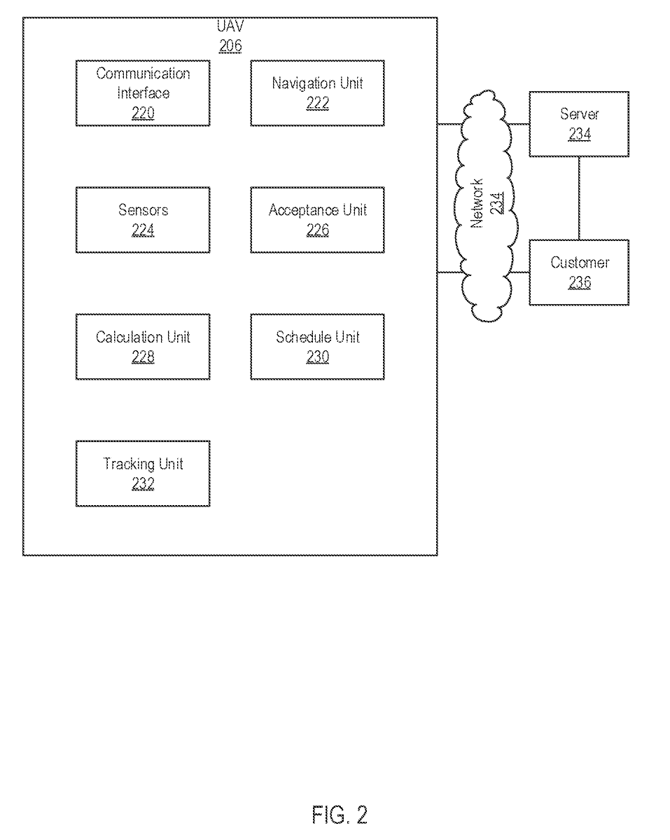

The UAV may be a remotely piloted aerial vehicle controlled by a remotely located human pilot, an unpiloted aerial vehicle controlled by a locally or remotely located automatic pilot, and/or the like. The UAV can include a number of systems to configure the UAV to deliver a package. For example, the UAV can include a communication interface, a navigation unit, a plurality of sensors, an acceptance unit, a calculation unit, a schedule unit, and/or a tracking unit, as shown in FIG. 2, among other systems.

The communication interface can receive message from a consumer and can send messages to a consumer. The communication interface can also receive/send messages from/to a delivery system that coordinates the actions of the UAV. The navigation unit can navigate the UAV to a consumer and from the consumer to a destination of the package. The navigation unit can pilot the UAV autonomously and/or may pilot the UAV based on instructions received from a remote source. Alternatively, or in addition, the remote instructions may bypass the navigation unit and be provided directly to flight control surfaces and/or the engine(s).

The sensors can collect information regarding the package to determine a plurality of characteristics of the package. The plurality of characteristics of the package can be used by the communication interface, the navigation unit, the acceptance unit, the calculation unit, the schedule unit, and/or the tracking unit to perform associated actions. For example, the plurality of characteristics of the package, determined by the sensors, can be used by a navigation unit to determine a route of delivery of the package.

The acceptance unit can determine whether to accept the package. The acceptance unit can communicate, via the communication interface, with a user to present the consumer with a number of options associated with accepting the package. The calculation unit can calculate freight charges to deliver the package. The schedule unit can schedule pickup and delivery of a number of packages. The tracking unit can track an available weight and/or available dimensions that are available within the UAV to accept future packages.

Embodiments may include various steps, which may be embodied in machine-executable instructions to be executed by a computer system. A computer system includes one or more general-purpose or special-purpose computers (or other electronic devices). The computer system can be incorporated into the UAV such that the different units, interfaces, and/or sensors are executed on or coupled to the computing system. The computer system may include hardware components that include specific logic for performing the steps or may include a combination of hardware, software, and/or firmware.

Embodiments may also be provided as a computer program product including a computer-readable medium having stored thereon instructions that may be used to program a computer system or other electronic device to perform the processes described herein. The computer-readable medium may include, but is not limited to: hard drives, floppy diskettes, optical disks, CD-ROMs, DVD-ROMs, ROMs, RAMs, EPROMs, EEPROMs, magnetic or optical cards, solid-state memory devices, or other types of media/computer-readable media suitable for storing electronic instructions.

Computer systems and the computers in a computer system may be connected via a network. That is, the UAV may be connected to a customer and/or to a delivery system via a network. Suitable networks for configuration and/or use as described herein include one or more local area networks, wide area networks, metropolitan area networks, and/or “Internet” or IP networks, such as the World Wide Web, a private Internet, a secure Internet, a value-added network, a virtual private network, an extranet, an intranet, or even standalone machines which communicate with other machines by physical transport of media (a so-called “sneakernet”). In particular, a suitable network may be formed from parts or entireties of two or more other networks, including networks using disparate hardware and network communication technologies. The network may include a wireless network. For example, the UAV may be connected to the world wide web via a wireless network such as a cellular network and/or a WiFi network.

One suitable network includes a server and several clients; other suitable networks may contain other combinations of servers, clients, and/or peer-to-peer nodes, and a given computer system may function both as a client and as a server. Each network includes at least two computers or computer systems, such as the server and/or clients. A computer system may include a workstation, laptop computer, disconnectable mobile computer, server, mainframe, cluster, so-called “network computer” or “thin client,” tablet, smart phone, personal digital assistant or other hand-held computing device, “smart” consumer electronics device or appliance, medical device, or a combination thereof.

The network may include communications or networking software, such as the software available from Novell, Microsoft, Artisoft, and other vendors, and may operate using TCP/IP, SPX, IPX, and other protocols over twisted pair, coaxial, or optical fiber cables, telephone lines, radio waves, satellites, microwave relays, modulated AC power lines, physical media transfer, and/or other data transmission “wires” and/or wireless protocols known to those of skill in the art. The network may encompass smaller networks and/or be connectable to other networks through a gateway or similar mechanism.

Each computer system includes at least a processor and a memory; computer systems may also include various input devices and/or output devices. The processor may include a general-purpose device, such as an Intel®, AMD®, or other “off-the-shelf” microprocessor. The processor may include a special-purpose processing device, such as an ASIC, a SoC, a SiP, an FPGA, a PAL, an PLA, an FPLA, a PLD, or other customized or programmable device. The memory may include static RAM, dynamic RAM, flash memory, one or more flip-flops, ROM, CD-ROM, disk, tape, magnetic, optical, or other computer storage medium. The input device(s) may include a keyboard, mouse, touch screen, light pen, tablet, microphone, sensor, or other hardware with accompanying firmware and/or software. The output device(s) may include a monitor or other display, printer, speech or text synthesizer, switch, signal line, or other hardware with accompanying firmware and/or software.

The computer systems may be capable of using a floppy drive, a tape drive, an optical drive, a magneto-optical drive, or other means to read a storage medium. A suitable storage medium includes a magnetic, an optical, or other computer-readable storage device having a specific physical configuration. Suitable storage devices include floppy disks, hard disks, tape, CD-ROMs, DVDs, PROMs, random access memory, flash memory, and other computer system storage devices. The physical configuration represents data and instructions which cause the computer system to operate in a specific and predefined manner as described herein.

Suitable software to assist in implementing the invention is readily provided by those of skill in the pertinent art(s) using the teachings presented here and programming languages and tools, such as Java, Pascal, C++, C, database languages, APIs, SDKs, assembly, firmware, microcode, and/or other languages and tools. Suitable signal formats may be embodied in analog or digital form, with or without error detection and/or correction bits, packet headers, network addresses in a specific format, and/or other supporting data readily provided by those of skill in the pertinent art(s).

Several aspects of the embodiments described will be illustrated as software modules or components. As used herein, a software module or component may include any type of computer instruction or computer executable code located within a memory device. A software module may, for instance, include one or more physical or logical blocks of computer instructions, which may be organized as a routine, program, object, component, data structure, etc., that perform one or more tasks or implement particular abstract data types.

In certain embodiments, a particular software module may include disparate instructions stored in different locations of a memory device, different memory devices, or different computers, which together implement the described functionality of the module. Indeed, a module may include a single instruction or many instructions, and may be distributed over several different code segments, among different programs, and across several memory devices. Some embodiments may be practiced in a distributed computing environment where tasks are performed by a remote processing device linked through a communications network. In a distributed computing environment, software modules may be located in local and/or remote memory storage devices. In addition, data being tied or rendered together in a database record may be resident in the same memory device, or across several memory devices, and may be linked together in fields of a record in a database across a network.

Much of the infrastructure that can be used according to the present invention is already available, such as: general-purpose computers, computer programming tools and techniques, computer networks and networking technologies, digital storage media, authentication; access control, and other security tools and techniques provided by public keys, encryption, firewalls, and/or other means.

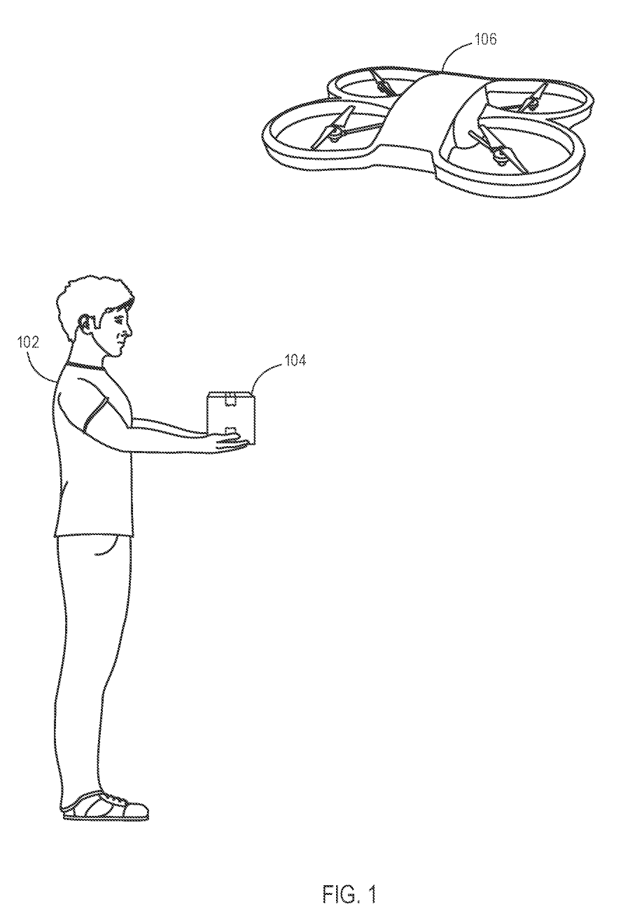

FIG. 1 is a perspective view of an UAV 106 configured to transport a package 104. A customer 102 can be in possession of a package 104. The customer 102 can contact a package delivery system, as described in FIG. 2, to request a delivery of the package 104.

The package communication interface can receive a request from the customer 102 to transport the package 104. The package communication interface can forward the request to the UAV 106 and/or can provide instructions to the UAV 106 to pick up the package 104 at a location specified by the customer 102 in the request.

In one embodiment, the UAV 106 includes a communication interface configured to receive a request to transport the package 104 from the package delivery system. The UAV 106 also includes a navigation unit configured to direct the UAV 106 to the package 104. The UAV 106 also includes a sensor configured to determine one or more physical characteristics of the package 104.

The one or more physical characteristics of the package 104 can include a weight of the package 104 and a plurality of dimensions of the package 104, among other physical characteristics of the package 104. In a number of examples, the one or more physical characteristics of the package 104 can include characteristics that are detectable by a sensor of the UAV 106.

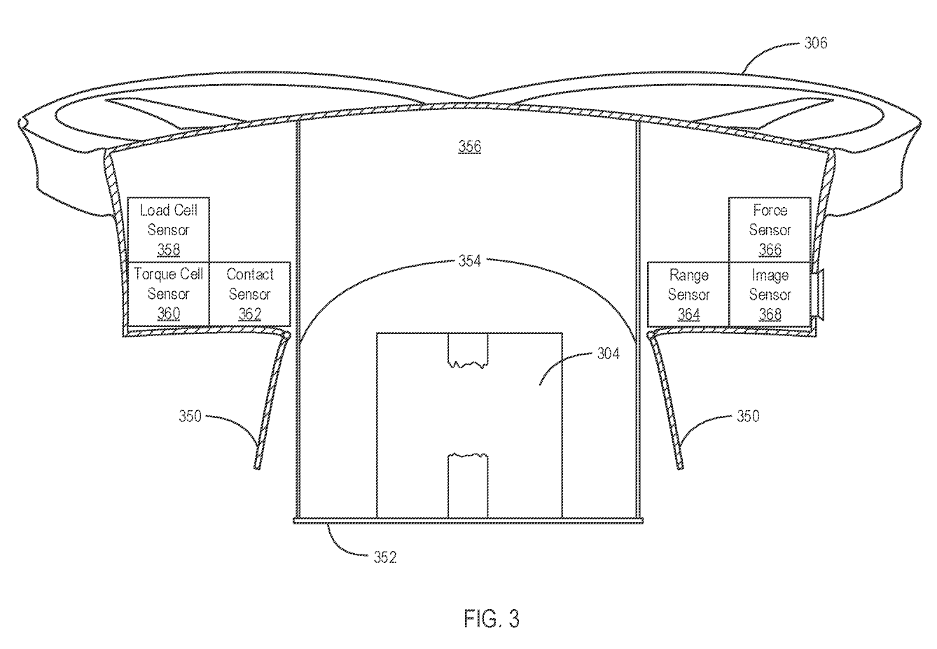

The UAV 106 further includes an acceptance unit configured to accept the package 104 for transport in response to the one or more physical characteristics satisfying a set of criteria. The set of criteria are further described in FIG. 3. If the one or more physical characteristics of the package 104 satisfy the set of criteria, then the UAV 106 delivers the package 104. If the one or more physical characteristics do not satisfy the set of criteria, the UAV 106 can decline acceptance of the package 104 or move the package 104 to a predetermined location pending acceptance by the acceptance unit.

For example, the UAV 106 can accept the package 104 notwithstanding that the physical characteristics of the package 104 do not satisfy the set of criteria. The UAV 106 can begin delivery of the package 104 and/or navigate to a predetermined location to await further instructions from the package delivery system. The customer 102 can be informed that the package 104 does not satisfy the set of criteria and can be informed of options to satisfy the set of criteria. For example, the package delivery system can request additional freight charges to complete the transport of the package 104 via the UAV 106. If the customer 102 declines to make the additional freight charges, then the package delivery system can inform the customer 102 of a location to pick up the package 104 that has not been delivered to a predefined destination.

In another embodiment, the UAV 106 comprises the communication interface configured to receive a request to transport the package 104 from the customer 102, the navigation unit configured to direct the UAV 106 to the package 104, the sensor configured to determine one or more physical characteristics of the package 104, and a calculation unit configured to calculate adjusted freight charges by comparing anticipated freight charges based on one or more physical characteristics of the package 104 specified in the request to the one or more physical characteristics of the package 104 determined by the sensor, and the acceptance unit configured to accept the package 104 for transport based on the acceptance of the adjusted freight charges by the customer 102.

The customer 102 can request that the package 104 be delivered by the package delivery system. The request can describe the one or more physical characteristics of the package 104. The one or more physical characteristics of the package 104 described in the request can be described as one or more anticipated physical characteristics of the package 104. The package delivery system can quote a price to deliver the package 104 based on the anticipated physical characteristics of the package 104. The quoted price can be described as the anticipated freight charge.

The one or more physical characteristics as determined by the sensors can be described as one or more determined physical characteristics of the package 104. The package delivery system and/or the UAV 106 can adjust the freight charge based on the one or more anticipated physical characteristics of the package 104 not matching the one or more determined physical characteristics of the package 104. The adjusted freight charge can be adjusted based on the anticipated freight charge. The adjusted freight charge is further described in FIG. 2.

In another embodiment, the UAV 106 comprises the communication interface configured to receive a request to transport a package 104, the navigation unit configured to direct the UAV 106 to the package 104, a sensor configured to determine at least one of a weight and a plurality of dimensions of the package 104, and a schedule unit configured to adjust a pickup schedule for the package 104 based on the at least one of the weight and the plurality of dimensions of the package 104.

The pickup schedule is a schedule created by the package delivery system and/or the UAV 106. The UAV 106 can pick up and deliver a plurality of packages between services at the package delivery system. The pickup schedule can describe the order in which packages are picked up and/or delivered. For example, the UAV 106 can pick up a first package and a second package before the UAV 106 delivers the first package and/or the second package. The pickup schedule can be created based on the anticipated physical characteristics of the package as described in requests to deliver a number of packages. If the anticipated physical characteristics of the package do not match the determined physical characteristics of the package, then the UAV 106 may not have the capacity to continue with the pickup schedule. As such, the pickup schedule may be modified to accommodate the determined physical characteristics of a particular package being accepted and a plurality of anticipated physical characteristics of packages that are scheduled to be picked up.

In some embodiments, the delivery point of a package and a recipient identification (ID) of the recipient may be recorded. The recoding may be reported to a customer 102 and/or may be used in logging the activities of the UAV 106.

FIG. 2 is a schematic diagram of a UAV configured to transport a package. FIG. 2 includes a customer 202 and a UAV 206 which are analogous to the customer 102 and the UAV 106 in FIG. 1. FIG. 2 also includes a server 234 that is part of a package delivery system and a network 238.

The UAV 206 can include hardware and computer readable instructions. For example, the UAV 206 includes a communication interface 220, a navigation unit 222, a sensor 224, an acceptance unit 226, a calculation unit 228, a schedule unit 230 and/or a tracking unit 232. In a number of examples, the communication interface 220, the navigation unit 222, the sensor 224, the acceptance unit 226, the calculation unit 228, the schedule unit 230, and/or the tracking unit 232 can be implemented using any combination of hardware and computer readable instructions. For example, the communication interface 220 can include computer readable instructions executed on hardware to perform communication functions such as receiving and/or sending messages via the network 238.

The UAV 206 can be a vehicle that is selected from a group consisting of an unpiloted aerial vehicle and a remotely piloted aerial vehicle. The unpiloted aerial vehicle can include computer readable instructions and/or hardware to pilot a vehicle without the assistance of a human operator. A piloted aerial vehicle is a vehicle that includes hardware and computer readable instructions to receive commands from a human operator that pilots the UAV 206. For example, a human operator can provide navigation commands to the UAV 206 via the network 238 utilizing the server 234.

The network 238 can be a plurality of different types of networks and/or a combination of different types of networks as described above. For example, the customer 202 may communicate directly with the server 234 from a package delivery system and/or the customer 202 may communicate indirectly, via the network 238 with the server 234. Similarly, the customer 202 can communicate with the UAV 206 via the network 238 and the UAV 206 can receive the communications via the communication interface 220.

The customer 202 can utilize any combination of portable and/or desktop computing device to communication with the server 234 and/or the UAV 206. For example, the customer 202 can communicate with the server 234 utilizing a desktop computing device to request the delivery of a package. The customer 202 can then utilize a smart phone to communicate with the UAV 206 via the communication interface 202. FIG. 2 shows the communications between the customer 202 and the UAV 206 as going through the network 238. In a number of examples, the communications between the customer 202 and the UAV 206 can occur without traversing the network 238. Rather, the communications between the customer 202 and the UAV 206 can be direct without traversing the network 238.

The navigation unit 222 can include computer readable instructions and/or hardware configured to direct the UAV 206 from the package delivery system to the customer 202 to pick up the package. The navigation unit 222 can also direct the UAV 206 from the customer 202 after picking up the package to a plurality of different customers to pick up their packages along a pickup route that is associated with a pickup schedule. The navigation unit 222 can also direct the UAV 206 from the customer 202 after picking up the package to a delivery location. The navigation unit 222 can also direct the UAV 206 from the delivery location back to the package delivery system for maintenance and/or storage of the UAV 206.

The hardware and/or computer readable instructions that compose the navigation unit 222 can include GPS units and satellite antennas, among other hardware and/or computer readable instructions utilized by the navigation unit 222 to navigate the UAV 206. The navigation unit 222 can also access a number of controls of the UAV 206 to navigate the UAV 206. For example, the UAV 206 can access a propulsions system that moves the UAV 206 to navigate the UAV 206 from a first location to a second location.

The acceptance unit 226 can include hardware and/or computer readable instructions to accept a package onto the UAV 206 or decline a package from being loaded onto the UAV 206. The acceptance unit 226 can be configured to accept packages that do not exceed a threshold weight. The threshold weight is a weight limit of the UAV 206 and/or a weight limit for a particular package. A weight limit of the UAV 206 can be defined by a lifting energy of the UAV 206 and/or a combination of the lifting energy of the UAV 206 and the stored energy of the UAV 206.

The stored energy can be electricity and/or bio fuels among other types of energy (e.g., power). The stored energy of the UAV 206 can define a length of time that the UAV 206 can remain active while carrying a package of a particular weight.

If the threshold weight defines a weight limit of a particular package, then the threshold weight can be based upon a specified transport payment (e.g., freight charge). For example, the more that a package weights then the more that the UAV 206 may charge the customer.

If the threshold weight defines a weight limit of the UAV 206, then the threshold weight is a weight limit of the UAV taking into account one or more other packages that have been previously accepted or scheduled for transport. For example, if the UAV 206 has a first weight threshold and the UAV 206 accepts a first package, then the UAV 206 may be assigned a second weight threshold that is equal to the first weight threshold minus the weight of the first package. The UAV 206 can also define a weight threshold of a particular package by determining the weight threshold of the UAV 206 and subtracting the weight of the packages, excluding the particular package, that will be transported at a same time.

The acceptance unit 226 can be further configured to accept packages in response to a determination that the weight (e.g., determined weight) of the package is less than or equal to the reported weight (e.g., anticipated) of the package in the request. For example, if a determined weight of a package is less than or equal to an anticipated weight of the package, then the acceptance unit 226 may accept the package onto the UAV 206. If the determined weight of the package is greater than an anticipated weight of the package, then the acceptance unit 226 may decline to accept the package.

The acceptance unit 226 can further be configured to request a surcharge to accept a package based on a determination that the weight of the package is greater than the reported weight of the package. For example, if the determined weight of the package is greater than the anticipated weight of the package, then the UAV 206 can provide the customer 202 via the network 238 and the communication interface a request to pay additional freight charges. For example, the customer 202 may have already paid a freight charge to the package delivery system by providing the freight charge to the server 234. The acceptance unit 226 may request an additional freight charge based on the different between the determine weight of the package and/or the anticipated weight of the package. The acceptance unit 226 can be further configured to accept the package in response to payment of the surcharge.

The acceptance unit 226 can be configured to accept packages that do not exceed a weight that would require more than a threshold amount of fuel to transport the package. For example, the acceptance unit 226 can determine an amount of fuel that would be used to deliver a package. The threshold amount of fuel may be the amount of fuel that would be used to deliver the package. The threshold amount of fuel may be the amount of fuel that the UAV 206 currently carries minus the fuel needed to transport the UAV 206 to the storage and/or service location.

In a number of examples, the threshold amount of fuel may take into account an amount of fuel allotted to deliver other packages accepted or scheduled for transport. For example, a first threshold amount of fuel allotted to deliver a first package can be a total amount of fuel available to the UAV 206 minus a second threshold amount of fuel allotted to deliver a plurality of other packages. The first threshold amount of fuel allotted to deliver the first package can also be the total amount of fuel available to the UAV 206 minus the second threshold amount of fuel allotted to deliver a plurality of other packages and minus the fuel needed to transport the UAV 206 to the storage and/or service location.

The acceptance unit 226 can further be configured to accept packages that do not exceed a volume threshold. The one or more physical characteristics of the package can include a plurality of dimensions of the package. The plurality of dimensions of the package can be used to calculate a volume of the package. In a number of examples, the volume threshold can define a volume within the UAV 206 that is available to accept the package into the UAV 206. As such, if the calculated volume of the package is greater than the volume threshold, then the UAV 206 may not have the cargo space sufficient to accept the UAV 206. In a number of examples, the volume threshold for the package can be a volume within the UAV 206 that is available to accept the package into the UAV 206 considering a number of allotted volumes of a plurality of other packages that have not been accepted into the UAV 206 but are scheduled to be picked up by the UAV 206. In such an example, accepting a first package having a calculated volume that is greater than the volume threshold can include rearranging the pickup schedule such that a second package that was scheduled to be picked up is no longer scheduled to be picked up at the same time as the first package to make room within the UAV 206 for the calculated volume of the first package.

The acceptance unit can also be configured to accept packages that do not exceed a dimension threshold. For example, a dimension threshold of a UAV 206 can define a dimension limitation of the UAV 206. For example, a dimension threshold can define a height limitation of the UAV 206, a width limitation of the UAV 206, and/or a length limitation of the UAV 206. The dimension threshold for a package can define a cargo limitation of the UAV 206 to accommodate a particular dimension of the package. For example, a dimension threshold of the package can define a length, a width, and/or a height of the package that the UAV 206 can accept considering a plurality of lengths, widths, and/or heights of other packages that are scheduled to be picked up. That is, the dimension threshold can be a dimension limit of the UAV taking into account one or more other packages that have been previously accepted or scheduled for transport and/or delivery.

The acceptance unit 226 can accept a package in response to a determination that the one or more dimensions of the package are less than or equal to the one or more reported dimensions of the package in the request. In another example, the acceptance unit 226 can reject a package in response to a determination that the one or more dimensions of the package are greater than the one or more reported dimension of the package in the request to transport the package. The acceptance unit 226 can request a surcharge to accept the package based on the determination that the one or more dimensions of the package are greater than the reported one or more dimensions of the package. The surcharge can be based on the added cost to deliver the package based on the difference between at least one of the one or more dimensions of the package as compared to an associated reported one or more dimensions of the package.

The sensor unit 224 can include hardware and/or computer readable instructions to determine a plurality of characteristics of the package. The sensor unit 224 is further described in FIG. 3.

The calculation unit 228 can include hardware and/or computer readable instructions executable to request additional payment in response to an increase of the adjusted freight charges as compared to the anticipated freight charges. In a number of examples, the calculation unit 228 can communicate with the communication interface 220, the navigation unit 222, the acceptance unit 226, the schedule unit 230, and/or the tracking unit 232 to request additional payment. For example, the calculation unit 228 can communicate with a customer 202 via the communication interface 220. In another example, the acceptance unit 226 can determine that the anticipated one or more physical characteristics of the UAV 206 do not match the one or more anticipated physical characteristics of the UAV 206. The acceptance unit 226 can then request that the calculation unit 228 determine the appropriate action to collect additional payments or reimburse payment to the customer 202.

The additional payment can be proportional to the increase of the adjusted freight charges as compared to the anticipated freight charges. The anticipated freight charges can be quoted by a package delivery system at the time the request to deliver a package is received. The adjusted freight charges can be based on a determined one or more physical characteristics of the package. The additional payment can be the difference between the adjusted freight charges and the anticipated freight charges.

For example, the adjusted payment can be based on a determination that the increase of the adjusted freight charges is greater than a threshold. For example, if the adjusted freight charges are greater than a threshold, then an adjusted payment can be calculated and if the adjusted freight charges are less than or equal to the threshold, then the adjusted payment can be omitted. As such, the adjusted payment can be requested from a customer 202 if the difference between the determined one or more physical characteristics of the package and the anticipated one or more physical characteristics of the package is greater than a predetermined threshold. This provides the customer 202 leeway in reporting the one or more physical characteristics of the package without being charged more if the determined one or more physical characteristics of the package are off by a small margin.

The adjusted freight charges can be decreased as compared to the anticipated freight charges in response to at least one of the determined physical characteristics of the package being greater than an associated one of the anticipated physical characteristics of the package. This can occur when, for example, the customer 202 over-reported at least one of the physical characteristics of the package in the request to deliver the package.

The calculation unit 228 can provide a rebate to the customer 202 in response to a decrease of the adjusted freight charges as compared to the anticipated freight charges. The rebate can be proportional to the decrease of the adjusted freight charges as compared to the anticipated freight charges. For example, the rebate can be the difference between the adjusted freight charges and the anticipated freight charges. The rebate can also be a percentage of the difference between the adjusted freight charges and the anticipated freight charges. In another example, the rebate is provided to the customer in response to a determination that the decrease of the adjusted freight charges is greater than a threshold. This provides leniency in providing a rebate based on the difference between the anticipated physical characteristics of the package and the determined physical characteristics of the package, as the adjusted freight charges and the anticipated freight charges are based on the determined physical characteristics of the package and the anticipated physical characteristics of the package, respectively. As such, the adjusted freight charges can be proportional to the one or more determined physical characteristics of the package and/or the difference between the determined physical characteristics of the package and the anticipated physical characteristics of the package.

The adjusted freight charges can be based on the one or more determined physical characteristics of the package exceeding one or more thresholds. The adjusted freight charges can also be based on a determination that the difference between the determined physical characteristics of the package and the anticipated physical characteristics of the package is greater than a threshold.

The adjusted freight charges can also be based on at least one of fuel and/or energy needed to transport the package. For example, if the determined physical characteristics of the package are greater than the anticipated physical characteristics of the package, then a delivery of the package can consume more fuel and/or energy than was anticipated in creating the anticipated freight charges. As such, the adjusted freight charges can be based on the fuel and/or energy needed to transport the package and/or on the difference between the anticipated fuel and/or energy needed to transport the package and the determined fuel and/or energy needed to transport the package.

The adjusted freight charges can also be based on the flight time needed to transport the package. The flight time can represent a number of factors that contribute to the costs of delivering a package. For example, the flight time can represent the energy consumed to deliver a package.

Furthermore, the adjusted freight charges can be based on wear to the UAV 206 in delivering the package, for example, wear to an engine (e.g., propulsion system), wear to an energy storage system (e.g., batteries), and/or wear to other parts of the UAV 206. The adjusted freight charges can also be based on changes to a delivery route employed to deliver the package. Changes to a delivery route can also affect flight time, wear to the UAV 206, and/or the ability to accept additional packages, all of which can have an effect on the costs associated with delivering the package. For example, the freight charges can be based on changes to future payloads to accommodate overages on a current payload. If the determined physical characteristics of the package are greater than the anticipated physical characteristics of the package, then accepting the package can affect future payloads such that the UAV 206 may not be able to accept packages that were scheduled to be picked up. As such, the freight charges can be adjusted to compensate for the inability to accept packages that were scheduled to be picked up.

In a number of examples, the adjusted freight charges can be calculated before the UAV 206 initiates flight and/or accepts the package. Furthermore, the adjusted freight charges can be presented to a customer before the UAV initiates flight or accepts the package. If the package was placed in/on the UAV 206 to allow the sensors 224 to determine the physical characteristics of the package, then the package can be off-loaded in response to an indication by the customer 202 not to accept the adjusted freight charges.

The schedule unit 230 can include hardware and/or computer readable instructions to provide the available weight and the available dimensions to potential customers to describe an availability of the UAV to transport packages. The scheduling unit 230, for example, can report the used space in the UAV 206 and/or the unused space in the UAV 206 to the server 234. Upon receipt of the request to deliver the package, from the customer 202 at the server 234, the server 234 can determine whether the UAV 206 has the capacity to deliver the package. The server 234 can provide the customer 202 with a number of options for delivery of the package based on the reported capacity of a plurality of UAVs. The number of options can include routes, UAVs, and/or concurrent delivery of other customers' packages with the package of customer 202.

The schedule unit 230 can further be configured to rearrange an order in which packages that are scheduled to be picked up are picked up based on the available weight and the available dimensions in the UAV 206. For example, if the UAV 206 is in the process of delivering a plurality of packages but continues to have space to accept additional packages, then the schedule unit 230 can rearrange the order in which packages are scheduled to be picked up to accommodate the acceptance of an additional package. Before rearranging the order in which packages are picked up, the schedule unit 230 can determine the available weight and/or dimensions in the UAV 206.

The schedule unit 230 can determine the available weight and/or dimensions by requesting the available weight and/or dimensions from the tracking unit 232. The tracking unit 232 includes hardware and/or computer readable instructions to at least track an available weight and/or dimensions in the UAV 206. If the anticipated weight and/or dimensions of a package scheduled to be picked up is greater than the available weight and/or dimensions of a UAV 206, then the schedule unit 230 can rearrange the pickup schedule to accommodate the anticipated weight and/or dimensions of the package scheduled to be picked up. For example, the schedule unit 230 can create a separate pickup schedule for the scheduled package or unschedule a different scheduled package to make room for the scheduled package, among other possible schedule modifications.

The schedule unit 230 can adjust a pickup time for packages that are scheduled to be picked up based on the available weight and the available dimensions in the UAV 206. The pickup time for packages can be adjusted due to a change in route used by the UAV 206 to arrive at each of the packages. The route can be changed due to a number of circumstances such as weather, customer 202 interaction, or UAV 206 malfunction, among other possible reasons for a change of route. The route can also be changed due to scheduled pickups that are unable to be accommodated due to at least one of the available weight and the available dimensions in the UAV 206. For example, if a package was scheduled to be picked up but the UAV 206 is unable to pick up the scheduled package due of a limitation of weight and/or dimensions, then the pickup route can be changed to exclude the package that was scheduled to be picked up.

The pickup time for packages to be picked up can also be adjusted due to slower flight speed than was anticipated due to a plurality of factors such a wind speed resistance. The speed of the flight is based on at least one of the weight and the plurality of dimensions of the package.

FIG. 3 is a cross sectional view of a UAV 306 configured to deliver a package 304. The UAV 306 includes a load cell sensor 358, a torque cell sensor 360, a contact sensor 362, a range sensor 364, a force sensor 366, and/or an image sensor 368, referred to herein as sensors. The UAV 306 also includes a cargo bay 356 (e.g., cargo space), a plurality of doors 350, and a pickup system comprising a base 352 and a retracting system 354.

Although FIG. 3 shows a particular pickup system comprising the base 352 and the retracting system 354, the pickup system may be a different system that enables the UAV 306 to accept the package 304 and/or determine the one or more physical characteristics of the package 304. As used in FIG. 3, the one of more physical characteristics include a weight of the package 304 and/or dimensions of the package 304. A weight of the package 304 can also include a mass of the package 304. The sensors can be used to determine the physical characteristics of the package 304.

The pickup system can direct the doors 350 to open upon arriving at a location identified by the request to deliver the package 304. The pickup system can direct the retracting system 354 to lower the base 352. The customer can then insert and/or lay the package 304 into/onto the base 352. The UAV 306 can then utilize the sensor to determine the weight and/or dimensions of the package 304.

In a number of examples, the UAV 306 can determine the weight and/or dimensions of the package 304 before loading/accepting the package 304. For example, the UAV 306 can utilize the image sensor 368 to determine the dimensions of the package 304 while the customer is holding the package 304. The UAV 306 can also instruct the customer to lay the package on the ground to allow the UAV 306 to determine a weight and/or dimensions of the package 304.

As used herein, the pickup system can be a mechanism to receive the package 304 into the storage area. The acceptance unit can control the mechanism to receive the package 304 into the storage area. In a number of examples, the pickup system can be coupled to the sensors to provide the means by which the sensors can determine the weight and/or dimensions of the package 304.

The cargo bay 356 can be a storage area that is utilized by the UAV 306 to store the package 304 during the delivery of the package 304. The cargo space 356 can be internal to the UAV 306 as shown in FIG. 3 and/or external to the UAV 306, not shown. An example of a cargo bay 356 that is external can include a container that is suspended under the UAV 306.

The sensors can include sensors to determine the weight of the package 304 and/or sensors to determine a plurality of dimensions of the package 304. For example, the sensors used to determine the weight of the package 304 include the load cell sensor 358, the torque cell sensor 360, the contact sensor 362, and/or the force sensor 366 among other types of sensors used to determine the weight of the package 304. The sensors can also include sensors to determine the dimensions of the package 304. For example, the sensors used to determine the dimensions of the package 304 can include the range sensor 364 and/or the image sensor 368. The image sensor 368 can include a camera. In a number of examples, the image sensor 368 can sense images external to the UAV 306 and/or internal to the UAV 306.

In a number of examples, the sensors can determine the weight of the package 304 in response to the UAV 306 lifting the package. For example, the sensors can determine the weight of the package 304 based on the lift-energy needed to lift the package 304. The weight of the package 304 can be determined based on the difference between the lift-energy needed to lift the UAV 306 without the package 304 and the lift-energy needed to lift the UAV 306 with the package 304.

The sensors can also determine the weight of the package 304 based on motion of the UAV 304 with the package 304 in response to a specified force. For example, the weight of the package 304 can be based on a force applied to the UAV 306 and a motion of the UAV 306 caused by the force given the package 304 is in the UAV 306. The sensors can also determine the weight of the package 304 based on motion of the UAV 306 with the package 304 in response to a specified torque. The sensors can determine the weight of the package 304 based on a difference between a first lift-energy needed to lift the UAV 306 without the package 304 and a second lift-energy needed to lift the UAV 306 with the package 304.

In a number of examples, the sensors can also comprise a radiation transmitter and/or a radiation receiver.

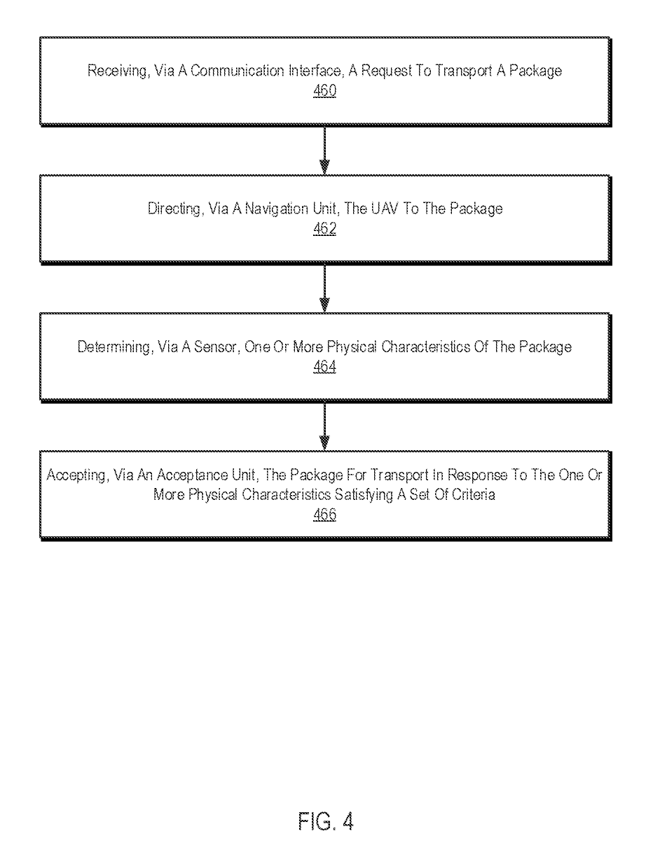

FIG. 4 is a flow diagram of a method for transporting a package via a UAV. The method comprises receiving 460, via a communication interface, a request to transport a package. The method also comprises directing 462, via a navigation unit, the UAV to the package. The method also comprises determining 464, via a sensor, one or more physical characteristics of the package. The method also comprises accepting 466, via an acceptance unit, the package for transport in response to the one or more physical characteristics satisfying a set of criteria.

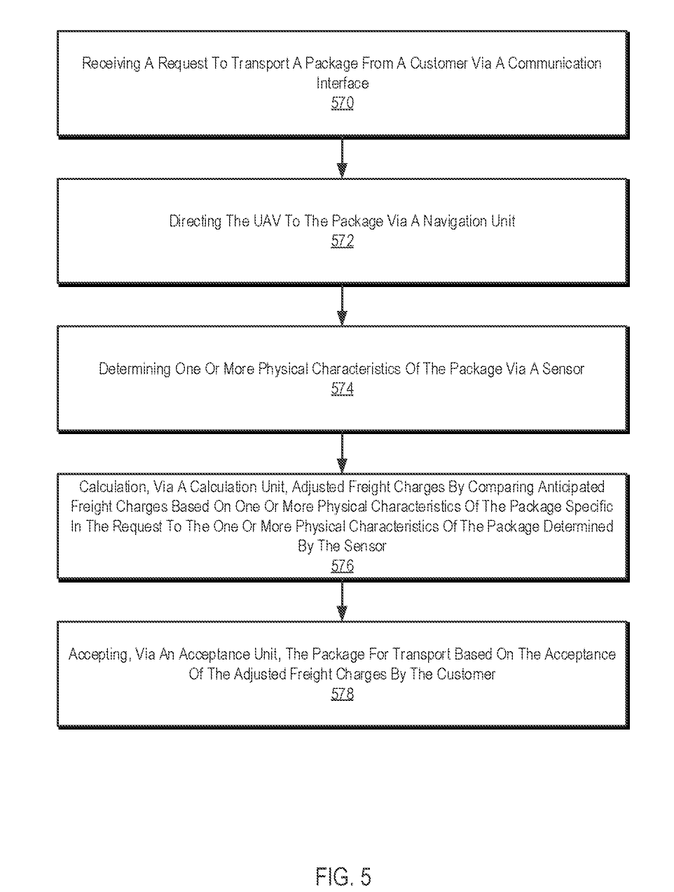

FIG. 5 is a flow diagram of a method for transporting a package via a UAV. The method comprises receiving 570, via a communication interface, a request to transport a package from a customer. The method also comprises directing 572, via a navigation unit, the UAV to the package via a navigation unit. The method further comprises determining 574 one or more physical characteristics of the package via a sensor and calculating 576, via a calculation unit, adjusted freight charges by comparing anticipated freight charges based on one or more physical characteristics of the package specified in the request to the one or more physical characteristics of the package determined by the sensor. The method also comprises accepting 578, via an acceptance unit, the package for transport based on the acceptance of the adjusted freight charges by the customer.

In some examples, calculating 576 the adjusted freight charges can include determining an expected fuel required to fly faster than is optimal for a UAV given a particular UAV configuration. Calculating 576 can also include determining a cost of the expected fuel and incorporating the cost of the expected fuel to the adjusted freight charges.

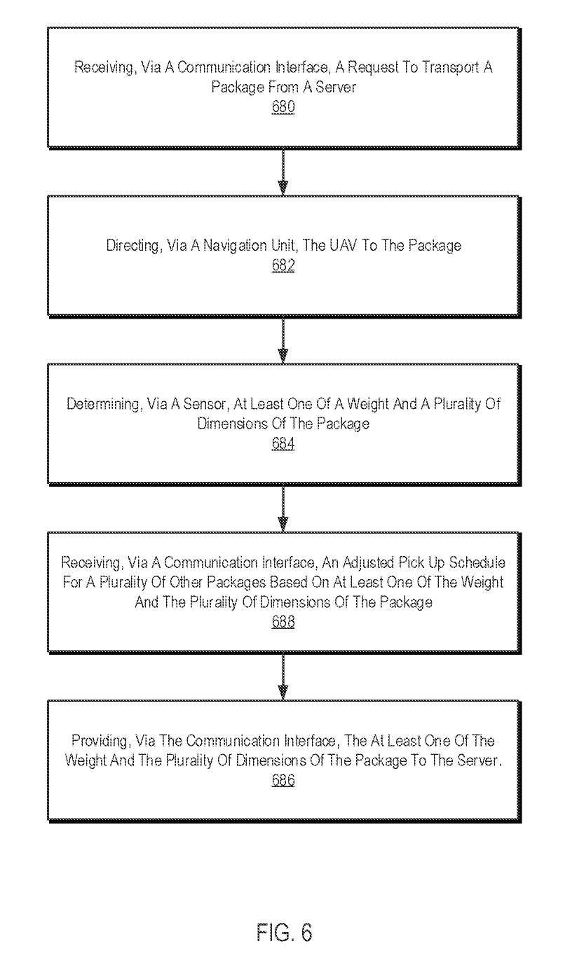

FIG. 6 is a flow diagram of a method for transporting a package via an UAV. The method comprises receiving 680, via a communication interface, a request to transport a package from a server. The method also comprises directing 682, via a navigation unit, the UAV to the package. The method also comprises determining 684, via a sensor, at least one of a weight and a plurality of dimensions of the package. The method further comprises providing 686, via the communication interface, the at least one of the weight and the plurality of dimensions of the package to the server. The method also comprises receiving 688, via a communication interface, an adjusted pickup schedule for a plurality of other packages based on the at least one of the weight and the plurality of dimensions of the package.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. An unmanned aerial vehicle (UAV) comprising:
a communication interface configured to receive a request to transport a package from a customer;
a navigation unit configured to direct the UAV to the package;
a sensor configured to determine one or more physical characteristics of the package;
a calculation unit configured to calculate adjusted freight charges by comparing anticipated freight charges based on one or more physical characteristics of the package specified in the request to the one or more physical characteristics of the package determined by the sensor; and
an acceptance unit configured to accept the package for transport based on the acceptance of the adjusted freight charges by the customer.

2. The UAV of claim 1, wherein the adjusted freight charges are based on changes in the one or more physical characteristics of the package compared to a corresponding value of the physical characteristic available to the UAV for transporting packages.

3. The UAV of claim 1, wherein the adjusted freight charges are based on changes in a corresponding value of the physical characteristic available to the UAV for transporting other packages.

4. The UAV of claim 3, wherein the adjusted freight charges are based on prevention of a previously scheduled payload from transportation within the UAV due to a decrease in the corresponding value of the physical characteristic available to the UAV.

5. The UAV of claim 1, wherein the adjusted freight charges are increased as compared to the anticipated freight charges in response to at least one of the determined physical characteristics of the package being greater than an associated one of the specified physical characteristics of the package.

6. The UAV of claim 1, wherein the calculation unit is further configured to request additional payment in response to an increase of the adjusted freight charges as compared to the anticipated freight charges.

7. The UAV of claim 6, wherein the additional payment is proportional to the increase of the adjusted freight charges as compared to the anticipated freight charges.

8. The UAV of claim 6, wherein the adjusted payment is based on a determination that the increase of the adjusted freight charges is greater than a threshold.

9-13. (canceled)

14. The UAV of claim 1, wherein the adjusted freight charges are based on the one or more determined physical characteristics of the package exceeding one or more thresholds.

15. The UAV of claim 1, wherein the adjusted freight charges are based on at least one of fuel and energy needed to transport the package.

16. The UAV of claim 1, wherein the adjusted freight charges are based on flight time needed to transport the package.

17. The UAV of claim 1, wherein the adjusted freight charges are based on changes to a delivery route employed to deliver the package.

18. The UAV of claim 1, wherein the adjusted freight charges are based on wear to the UAV in delivering the package.

19. The UAV of claim 18, wherein the wear to the UAV in delivering the package includes wear to an engine.

20. The UAV of claim 1, wherein the adjusted freight charges are based on changes to future payloads to accommodate overages on a current payload.

21-37. (canceled)

38. A method for transporting a package via an unmanned aerial vehicle (UAV) comprising:
receiving a request to transport a package from a customer via a communication interface;
directing the UAV to the package via a navigation unit;
determining one or more physical characteristics of the package via a sensor;
calculating, via a calculation unit, adjusted freight charges by comparing anticipated freight charges based on one or more physical characteristics of the package specified in the request to the one or more physical characteristics of the package determined by the sensor; and
accepting, via an acceptance unit, the package for transport based on the acceptance of the adjusted freight charges by the customer.

39-45. (canceled)

46. The method of claim 38, wherein the adjusted freight charges are decreased as compared to the anticipated freight charges in response to at least one of the determined physical characteristics of the package being greater than an associated one of the specified physical characteristics of the package.

47. The method of claim 46, further comprising providing, via the calculation unit, a rebate to a customer in response to a decrease of the adjusted freight charges as compared to the anticipated freight charges.

48. The method of claim 47, wherein the rebate is proportional to the decrease of the adjusted freight charges as compared to the anticipated freight charges.

49. The method of claim 47, wherein the rebate is provided to the customer in response to a determination that the decrease of the adjusted freight charges is greater than a threshold.

50. The method of claim 38, wherein the adjusted freight charges are proportional to the one or more determined physical characteristics of the package.

51-60. (canceled)

61. The method of claim 38, wherein the one or more determined physical characteristics and the one or more specified physical characteristics comprise at least one or more dimensions of the package and a weight of the package.

62-69. (canceled)

70. The method of claim 61, wherein the sensor comprises an image sensor.

71. The method of claim 70, wherein the image sensor comprises a camera.

72. The method of claim 61, wherein the sensor comprises a radiation transmitter and a radiation receiver.

73. The method of claim 72, wherein the sensor comprises a range sensor.

74. The method of claim 61, wherein the sensor comprises a contact sensor.

75. A non-transitory computer readable storage medium comprising program code configured to cause a processor to perform a method for transporting a package via an unmanned aerial vehicle (UAV) comprising:
receiving a request to transport a package from a customer via a communication interface;
directing the UAV to the package via a navigation unit;
determining one or more physical characteristics of the package via a sensor;
calculating, via a calculation unit, adjusted freight charges by comparing anticipated freight charges based on one or more physical characteristics of the package specified in the request to the one or more physical characteristics of the package determined by the sensor; and
accepting, via an acceptance unit, the package for transport based on the acceptance of the adjusted freight charges by the customer.

76-89. (canceled)

90. The non-transitory computer readable storage medium of claim 75, wherein the adjusted freight charges are based on flight time needed to transport the package.

91. The non-transitory computer readable storage medium of claim 75, wherein the adjusted freight charges are based on changes to a delivery route employed to deliver the package.

92-94. (canceled)

95. The non-transitory computer readable storage medium of claim 75, wherein the adjusted freight charges are calculated before the UAV initiates flight.

96. The non-transitory computer readable storage medium of claim 75, wherein the adjusted freight charges are presented to a customer before the UAV initiates flight.

97. (canceled)

98. The non-transitory computer readable storage medium of claim 75, wherein the one or more determined physical characteristics and the one or more specified physical characteristics comprise at least one or more dimensions of the package and a weight of the package.

99. The non-transitory computer readable storage medium of claim 95, wherein the sensor comprises a force sensor.

100. The non-transitory computer readable storage medium of claim 95, wherein the sensor comprises a load cell sensor.

101. The non-transitory computer readable storage medium of claim 95, wherein the sensor comprises a torque cell sensor.

102. The non-transitory computer readable storage medium of claim 95, wherein the sensor determines the weight of the package in response to the UAV lifting the package.

103. The non-transitory computer readable storage medium of claim 95, wherein the sensor determines the weight of the package based on lift-energy required to lift the package.

104. The non-transitory computer readable storage medium of claim 95, wherein the sensor determines the weight of the package based on motion of the UAV with the package in response to a specified force.

105. The non-transitory computer readable storage medium of claim 95, wherein the sensor determines the weight of the package based on motion of the UAV with the package in response to a specified torque.

106. The non-transitory computer readable storage medium of claim 95, wherein the sensor determines the weight of the package based on a difference between a first lift-energy required to lift the UAV without the package and a second lift-energy required to lift the UAV with the package.

107-111. (canceled)
